(19) United States
(12) Patent Application Publication
(10) Pub. No.: US 2024/0281836 A1
(43) Pub. Date: Aug. 22, 2024

(54) ANYTIME-VALID CONFIDENCE SEQUENCES WHEN TESTING MULTIPLE MESSAGING TREATMENTS

(71) Applicant: Adobe Inc., San Jose, CA (US)

(72) Inventors: Ritwik Sinha, Cupertino, CA (US); Ziao Liu, Redwood City, CA (US); Robert Sebastian Mares, Corbeanca (RO); Oana Catalina Persoiu-Focsa, Bucharest (RO); Moumita Sinha, Cupertino, CA (US); Ivan Andrus, Saratoga Springs, UT (US); David Arbour, San Jose, CA (US); Akash Maharaj, Palo Alto, CA (US); Prithvi Bhutani, Lynnwood, WA (US)

(21) Appl. No.: 18/110,620

(22) Filed: Feb. 16, 2023

(51) Int. Cl. G06Q 30/0203; G06F 17/18

(52) U.S. Cl. CPC G06Q 30/0203; G06F 17/18

(57) ABSTRACT

Certain aspects and features of this disclosure relate to providing anytime-valid confidence sequences for multiple messaging treatments in an experiment. A process controls and/or corrects statistical error when multiple messaging treatments are being evaluated together. Messages can be stored, formatted, and transmitted from a communication server or other computing system. In one example, each test message from among multiple test messages is sent to an independent group of recipients over some period of time. An analytics application programmatically evaluates a metric related to message responses over time and determines a difference in the metric for each of several unique messages as compared to a baseline message. The analytics application also determines a confidence value and can display the changing confidence value in sequence over time along with the current difference, or lift, while maintaining the accuracy of the values.

### TECHNICAL FIELD

The present disclosure generally relates to messaging, such as might be used communicate information to end users of a product or service. More specifically, but not by way of limitation, the present disclosure relates to statistically based techniques for evaluating various messaging treatments on an experimental basis in order to optimize message content, format, delivery channel, etc.

### BACKGROUND

A/B tests can be used for conducting experiments to determine which of two alternative commercial treatments, for example, alternative messages or kinds of messages to users or consumers, provides the best experience for the audience. The term “best” in this context can be defined differently depending on a goal to be achieved. For example, “best” can be defined in terms of some metric of significance for example, the portion of visitors to a web site or recipients of the message that respond positively in some way, or the average time that a user spends on a web site. The term “message” can refer to a text message, email message, push message, instant message, or the like. The term message can also refer to a web site, web page, or a portion thereof, considering design, color scheme, descriptive text, fonts, or any other characteristic. In order to conduct an A/B test of messaging treatments, two different messages are provided, and each is forwarded to or otherwise provided to a different group of recipients. Data describing the responses from within the two groups is collected and compared. This analysis can be used in determining the best alternative as between the two messages.

### SUMMARY

Certain aspects and features of the present disclosure relate to providing anytime-valid confidence sequences for multiple treatments. For example, a method involves transmitting each of multiple test messages to an independent group of recipients, and assaying, over time, using a response module, a metric corresponding to a message response from the independent group of recipients for each of the test messages. The method further involves deriving, iteratively over time using a difference module, a comparative difference between an assayed value of the metric for the message response and a baseline value of the metric. The method also involves estimating, iteratively over time using a variance module, a variance of an average of the metric for the test messages. The method involves calculating, iteratively over time using a confidence module and based on the variance and an error-corrected p-value normalized within confidence bounds, a current confidence value corresponding to a current difference value for the comparative difference. The method additionally involves displaying, while updating over time using an interface module, the current confidence value to produce a confidence sequence.

Other embodiments include corresponding computer systems, apparatus, and computer programs recorded on one or more computer storage devices, each configured to perform the actions of a method.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram showing an example of a computing environment that provides anytime-valid confidence sequences for multiple treatments according to certain embodiments.

FIG. 2 is a flowchart of an example of a process for providing anytime-valid confidence sequences for multiple treatments according to certain embodiments.

FIG. 3 is a graph illustrating an example of family-wise error rate when testing multiple treatments and obtaining anytime-valid confidence sequences according to certain embodiments.

FIG. 4 is a graph illustrating asymptotic, cumulative family-wise error rate when testing multiple treatments and obtaining anytime-valid confidence sequences according to certain embodiments.

FIG. 8 is a graph illustrating false discovery rate when testing multiple treatments and obtaining anytime-valid confidence sequences according to certain embodiments.

FIG. 6 is a graph illustrating asymptotic, cumulative false discovery rate when testing multiple treatments and obtaining anytime-valid confidence sequences according to certain embodiments.

FIG. 7 is a graph illustrating an example of a normal distribution wherein a p-value can be calculated to obtain anytime-valid confidence sequences for multiple treatments according to certain embodiments.

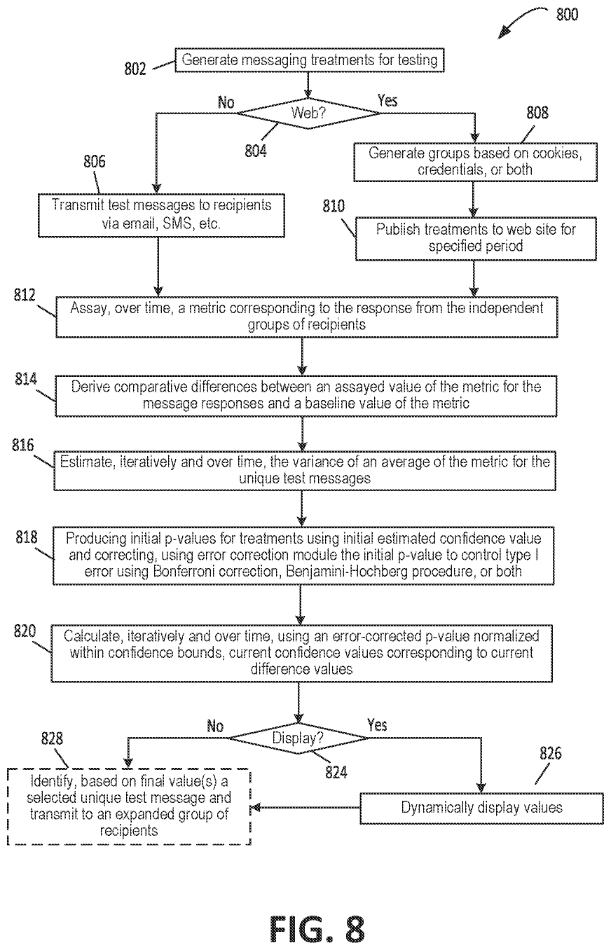

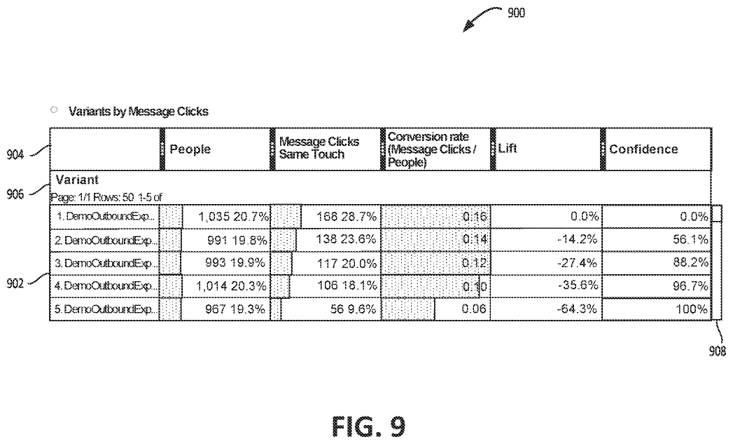

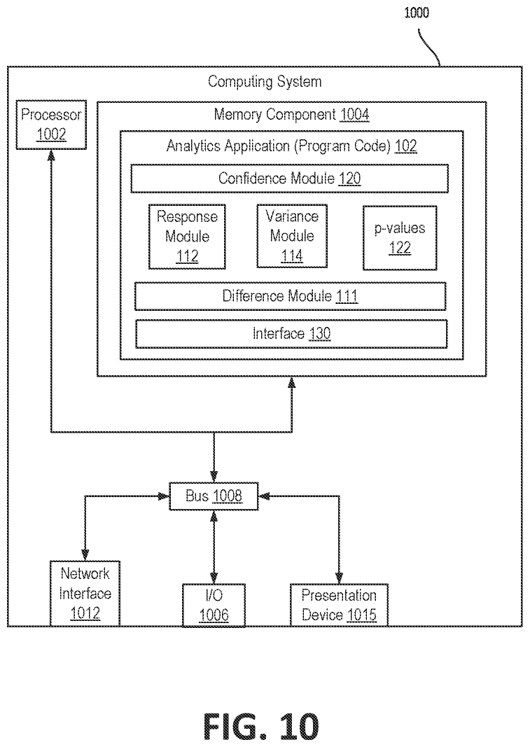

FIG. 8 is a flowchart of another example of a process for providing anytime-valid confidence sequences for multiple treatments according to certain embodiments.

FIG. 9 is screenshot of an example of a dynamic display for providing anytime-valid confidence sequences for multiple treatments according to certain embodiments.

FIG. 10 is a diagram of an example of a computing system that provides anytime-valid confidence sequences for multiple treatments according to certain embodiments.

### DETAILED DESCRIPTION

Messaging treatments can be tested and compared in pairs, by producing two different messages and forwarding or otherwise providing each message to a different group of recipients. One message is a baseline, perhaps a messaging treatment currently in use, and the other is a proposed, new message or a new type of message. Thus, a messaging treatment is compared against a control. Data describing the responses from within the two groups can be collected, characterized, and compared.

Such A/B testing can be conducted so as to provide an anytime-valid confidence sequence (ACS). An ACS provides a statistically useable confidence value for a current result of the test while the test is still running by controlling the type I statistical error (i.e., the rejection of a hypothesis that is actually true). An analyst can explore the results of the A/B test in real time, continuously monitoring and evaluating whether there is enough data to stop the test. ACS operates in contrast to normal confidence values, which are designed to control type I error only after a certain portion of the test has been completed, for example, at a pre-specified time when a certain sample size for the A/B test is reached.

It is desirable to test multiple treatments (messages) at once, to improve efficiency and reduce the amount of time required to test new messaging treatments. However, a real-time display of changing metrics and confidence values for large numbers of messaging treatments can be cumbersome. Additionally, ACS may not provide accurate confidence values when more than two messaging treatments are tested for comparison at the same time. Firstly, each hypothesis test evolves over time; thus, comparisons may be performed multiple times over time. Secondly, more than two comparisons are being performed across treatment arms; where there is one control arm, and k treatment arms, there are k pairwise comparisons with the control. When there is a collection of hypothesis tests where the null hypothesis is true for all of them (i.e., the treatment's effect is zero over time and for all treatment arms), the probability that at least one of the test messages is found to be a significant improvement over another erroneously grows to one as the number of comparisons increases. In addition to producing potentially inaccurate results, the growing numbers of statistical comparisons and probabilities result in an increasing computational load as a test is run, resulting in high latency in computing and displaying results.

Current paths to confidence sequences for messaging treatments are thus error-prone, computationally burdensome, or overly restrictive with respect to simultaneous testing. Embodiments described herein address these issues by providing a process that controls and/or corrects statistical error when multiple messaging treatments are being tested together. An estimated variance of the average treatment effect is computed and initially used to calculate the anytime-valid confidence sequence (ACS). A p-value is determined within confidence bounds for each messaging treatment based on the initially calculated ACS. The p-value can be corrected to control the type I error, using an error correction module to provide, as examples, a Bonferroni correction or a Benjamini-Hochberg procedure.

The use of corrected p-values normalized to be within confidence bounds provides a process that produces statistically valid, current confidence values irrespective of the number of messaging treatments being simultaneously tested. The confidence values are updated over time, and current values can be observed at any time during an experiment. The differences between treatments and the confidence values can be displayed in alignment with each other and scrolled as required by the number of messaging treatments being tested, while the values displayed are iteratively updated over time.

For example, an analytics application is executed on a computing system and provides testing and related statistical evaluation in connection with various messaging treatments to determine which one produces the most desirable results in terms of consumer response. The messages can be stored, formatted and sent from a communication server or from the same computing system that is used to execute the analytics application. Once a test is started, the analytics application causes the test messages to be sent. Each test message can be sent to an independent group of recipients over some period of time. The analytics application programmatically evaluates a metric related to message responses over time and determines a difference in the metric for each of several unique messages as compared to a baseline message. The analytics application also determines a confidence value for each of the several messages and can display these dynamically and sequentially over time. The analytics application can also display the current difference value, or “lift,” updating any or all of these values over time while maintaining the accuracy of the values.

In some examples, the analytics application can be configured to display valid current confidence values and current difference values along with test message identifiers in visual alignment on a display device. The display device can be configured by the analytics application to be scrollable while being iteratively updated over time with the sequence of values.

The use of normalized p-values provides sequences of statistically valid, current confidence values irrespective of the number of messaging treatments being tested. An analytics application as described herein can also control type I error by using an error correction module to correct the p-values using statistical procedures. The entire process is computationally light weight and thus scales easily to large numbers of simultaneous treatment arms, while still providing a low-latency display of accurate, live results. An analytics application may optionally be configured to identify, based on test results, a best message and automatically transmit that best message to an expanded group of recipients.

A “message,” as the term is used herein, can include any electronic communication. For example, a message can be a text message, an email message, a push message, or any message that is sent and received through a typical messaging application or the web. A message may also be an audio message sent through the audio feature of an application or via a telephone call.

A message can also be a web site, or a portion of a web site and testing may involve varying text, color schemes, images, or any other aspect of a web page. In such a case, transmitting the message may involve transmitting different versions of one or more web pages to different web browsers corresponding to various users.

As used herein, the terms, “p-value,” “variance,” “confidence,” and their values have the meanings normally understood in the field of statistics. An “error-corrected p-value” is a p-value that has been adjusted to eliminate type I statistical error. A “confidence sequence” is a recorded stream of confidence values stored for reference in a memory device and/or displayed, either sequentially or simultaneously. An anytime-valid confidence sequence (ACS) is a stream of statistically useable confidence values for a live, current result of a test even if the result is an intermediate result. The confidence values in an ACS can be derived any time from early on, when only a few responses have been received, through the conclusion of the test.

The term “treatment” as used herein is a plan for approaching potential customers or users in the normal course of business. A “messaging treatment” as the term is used herein refers to the content of a message to potential customers or users, as well as the manner in which it will be communicated, and optionally additional parameters regarding its application such as timing and duration.

The term “dynamically” as used herein, for example, to describe the display of results, refers to values being provided in such a manner that the values can be changed and updated continuously during a test. The term “selectively,” for example, as used in reference to “selectively displaying,” refers to an operation, such as displaying a certain value, which can take place or not based on a configuration parameter, or a selection made through an input device.

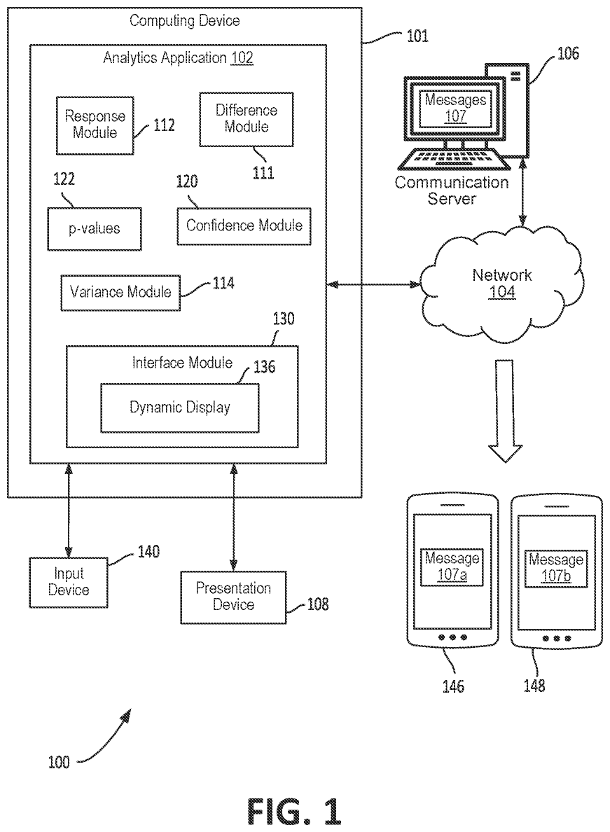

FIG. 1 is a diagram showing an example 100 of a computing environment that uses anytime-valid confidence sequences when testing multiple messaging treatments according to certain embodiments. The computing environment 100 includes a computing device 101 that executes an analytics application 102, a communication server 106, and a presentation device 108 that is controlled based on the analytics application 102. The communication server 106 is communicatively coupled to computing device 101 using network 104. Communication server 106 stores multiple unique messages 107, each targeted to a different, independent group of recipients. Communication server 106 may be a messaging server running a messaging application and/or an SMS gateway, a web server, a telecom server, or any other communication server that can format and transmit a message under the control of the analytics application 102. While a test is in process, ongoing results, including a sequence of confidence values over time, can be displayed on presentation device 108.

Still referring to FIG. 1, in this example, the analytics application 102 includes the difference module 111 for determining current differences for messaging treatments relative to a baseline, the response module 112 for assaying current response metric values, the variance module 114 for determining current variances, the confidence module 120 for calculating confidence values, and the stored p-values 122 being used to derive the confidence values. Analytics application 102 also includes an interface module 130. In some embodiments, the analytics application 102 uses input from input device 140 to configure information displayed on presentation device 108, or to configure, start, or stop a test. The analytics application 102 can render a dynamic display 136 to be output to presentation device 108. For example, the dynamic display may include a window with current confidence values, difference values, and test message identifiers configured to be in visual alignment on presentation device 108, so that data on many messaging treatments can be selectively observed by scrolling through messaging treatments using input device 140, while the data is being iteratively updated over time.

In addition to computing device 101, computing environment 100 includes computing device 146, which in this example is a mobile device receiving message 107a from among messages 107. Computing device 146 is connected to the communication server 106 through network 104. Computing environment 100 also includes computing device 148, which in this example is another mobile device, in this case receiving message 107b from among messages 107. Computing device 148 is also connected to the communication server 106 through network 104. Each of computing device 146 and computing device 148 receives a test message directed to a different independent group of recipients as part of a current test. Either or both of computing device 101 and communication server 106 can be implemented as either real or virtual (e.g., cloud-based) computing devices and can be implemented on any number of computing platforms.

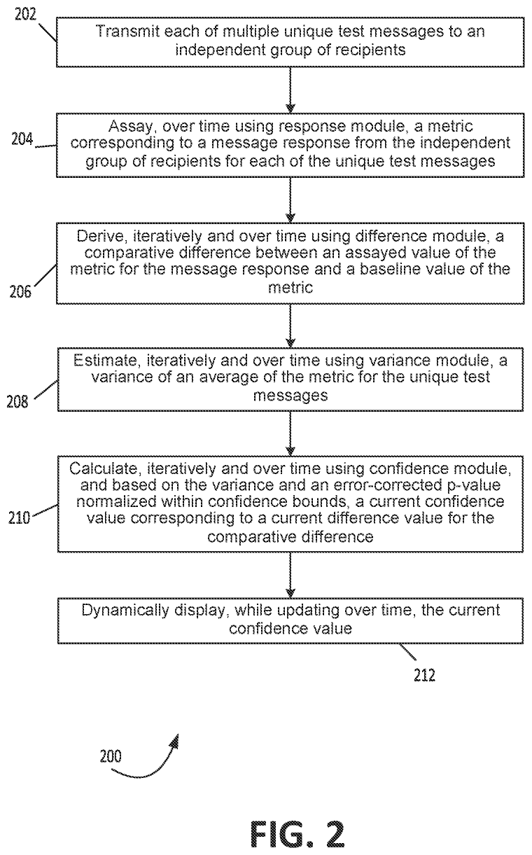

FIG. 2 is a flowchart of an example process 200 for anytime-valid confidence sequences when testing multiple messaging treatments according to some embodiments. In this example, a computing device carries out the process by executing suitable program code, for example, computer program code for an application, such as analytics application 102. At block 202, the computing device transmits each of multiple test messages to an independent group of recipients. One of these test messages represents a baseline treatment, for example, a message that is currently in use. At block 204, the computing device assays, over time using the response module, a metric corresponding to a message response for each independent group of recipients, in each case for the test message directed to the group, for example, for message 107a and message 107b in FIG. 1.

Continuing with FIG. 2, at block 206, the computing device derives, iteratively and over time using the difference module, a comparative difference between an assayed value of the metric for the message response and a baseline value of the metric. The difference in the value for each treatment of interest between the message being tested and the same metric applied to the baseline messaging treatment is determined. The metric is continuously determined, with the value possibly changing as the test proceeds. At block 208, the computing device estimates, iteratively over time using the variance module, a variance of an average of the metric for the test messages. At block 210, the computing device calculates, iteratively and over time using the confidence module, and based on the variance and an error-corrected p-value normalized within confidence bounds, a current confidence value for each messaging treatment. The confidence value corresponds to a current difference value for the comparative difference between the subject messaging treatment and the baseline messaging treatment. The confidence value indicates the likelihood that the test result for that message is meaningful and has not occurred by chance.

To define a confidence sequence for an individual messaging treatment, let \hat{μ}ₙ be the sample mean, and σₙ the sample standard deviation after n samples have been recorded. Then for any pre-specified constant ρ.

$${CS}_{1 - α} := \{ {\hat{μ}}_{n} \pm {\hat{σ}}_{n} \sqrt{\frac{2 ( n {ρ}^{2} + 1 )}{{n}^{2} {ρ}^{2}} log ( \frac{\sqrt{n {ρ}^{2} + 1}}{α} )} \} ,$$

forms a (1-a) confidence sequence (CS) for the true mean, μ. The parameter ρ is a free parameter that is tuned. It has been found that a value of ρ₂=10^{-2.8} works well. The confidence sequence bounds for a messaging treatment can be determined by adding the sum of users for the treatment, the sum of the metric, for example lift, for the treatment, and the sum of the squared metric for the particular treatment.

At block 212 the computing device displays, dynamically while updating over time, at least the current confidence value and the current difference value. For example, a dynamic display 136 can be output through the interface module 130 to the presentation device 108. In some examples, the displayed output at block 212 of process 200 is scrollable and can be updated while scrolling for optimized viewing and review of the valid confidence sequences for each treatment. These confidence values can be observed at any time during the experiment; the test does not need to be completed for valid confidence values to be displayed. A screenshot of an example display will be discussed below with respect to FIG. 6.

8For processing the conversions, it can be assumed that some recipients “convert” multiple times. The number of conversions at any given time can be modeled as the Poisson distribution:

$${c}_{u i} ∼ Poisson ( {λ}_{i} ) ,$$

with λᵢ varying. Note that in some contexts, the binarized conversion rate of this model may be of greater interest. The binarized conversion rate ρᵢ is the fraction of users that convert, and is related to the average number of conversions λᵢ by ρᵢ=1−e^{-λ}^{ᵢ}

For processing conversions to produce anytime valid confidence sequences, it can be assumed that the time delay between an assignment event and a conversion event follows an exponential distribution, with one day being the average response time, and that these characteristics do not vary between treatment arms. Thus, if assignment events (messages) are sent uniformly over the course of the campaign conversion events will be spread out exponentially over time after that.

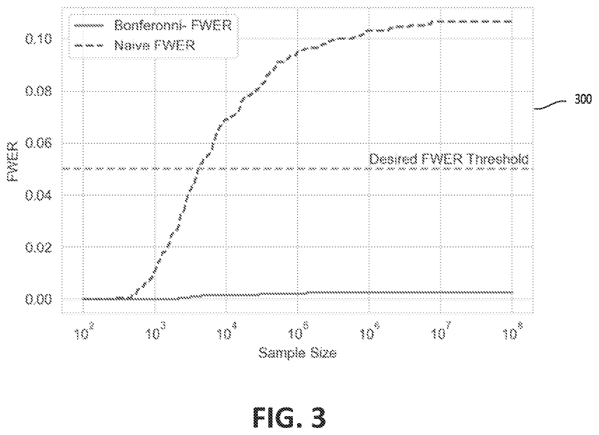

FIG. 3 is a graph 300 illustrating family-wise error rate when testing multiple treatments and obtaining anytime-valid confidence sequences according to certain embodiments. Without family-wise error control, the anytime-valid process can violate asymptotic error guarantees. Graph 300 shows the cumulative family-wise error rate (FWER) both with and without Bonferroni correction for five null hypotheses (an A/B test with six arms, all simulated to have equal conversion rates), which is monitored continuously (peeks for every ten new visitors) up to a sample size of 100 million visitors in each arm. The asymptotic FWER is not controlled unless the Bonferroni procedure is applied.

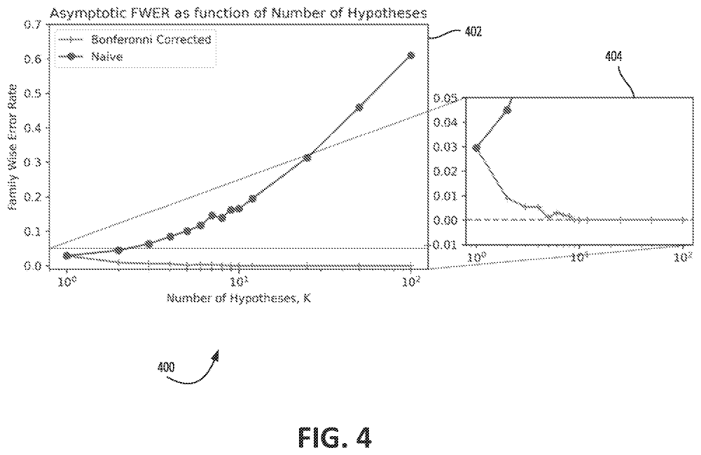

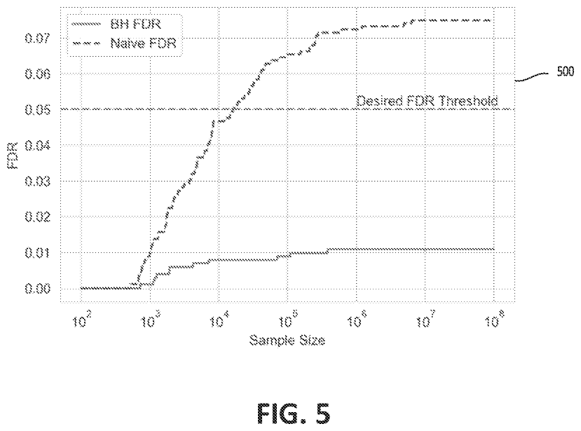

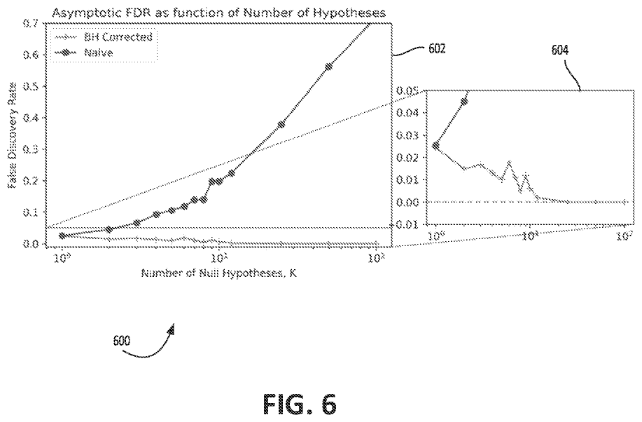

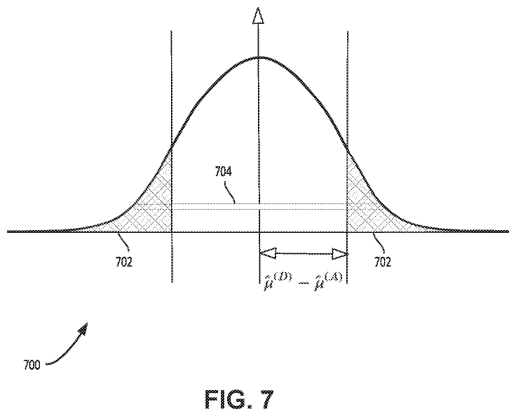

FIG. 4 includes graphs 400 illustrating asymptotic, cumulative family-wise error rate when testing multiple treatments and obtaining anytime-valid confidence sequences according to certain embodiments. As the number of treatment arms in the experiment increases, this asymptotic error rate increases without the Bonferroni correction. The asymptotic cumulative family-wise error rate at 10 million visitors per treatment arm, as the number of arms increases is shown in graph 402. The FWER trends towards one (i.e. at least one null hypothesis is incorrectly rejected in every experiment) as the number of treatment arms increases. Applying the Bonferroni correction forces this FWER towards zero. Graph 404 is an exploded view of the very beginning of graph 402.

FIG. 5 is a graph 500 illustrating false discovery rate when testing multiple treatments and obtaining anytime-valid confidence sequences according to certain embodiments. For false discovery rate (FDR) control via the Benjamini-Hochberg procedure, a similar story emerges. The cumulative FDR is shown in FIG. 5, with and without the Benjamini-Hochberg procedure, for an experiment with five treatment arms—three of which have conversion rates equal to the baseline/control arm, and one of which has a different conversion rate. The FDR threshold of 0.05 is crossed if no Benjamini-Hochberg procedure is applied. On the other hand, application of the Benjamini-Hochberg procedure in this example controls the cumulative False Discovery Rate well below the target threshold.

FIG. 6 includes graphs 600 illustrating asymptotic, cumulative false discovery rate when testing multiple treatments and obtaining anytime-valid confidence sequences according to certain embodiments. The scaling of the asymptotic, cumulative FDR is also well controlled by the Benjamini-Hochberg procedure as the number of treatment arms increases. Graph 602 shows the FDR as the number of null hypotheses changes (the simulation setup always involves a baseline/control arm in the A/B test, along with a single non-null treatment arm). Without the Benjamini-Hochberg correction, the False discovery rate approaches one (i.e., nearly every “discovery” or rejection of the null hypothesis becomes a false one). Graph 604 is an exploded view of the very beginning of graph 602.

The calculation of p-values and confidence values in some examples can be accomplished in four operations. Firstly, storage is allocated for computations with respect to a baseline treatment. Thus, if a different unique test message is sent to four different groups of recipients for four messaging treatments, there will be three p-values at any given time since these are calculated with respect to a treatment that is a baseline treatment. For example, the baseline treatment may be selected as the treatment already in use. Secondly, a 95% confidence sequence is computed for each treatment effect. An inverse propensity weighted estimator can be used for this computation. Thirdly, confidence bounds are used to estimate a sampling distribution for each treatment effect to restrict and normalize the variance and p-values. Finally, each p-value is computed based on a probability an observation being more extreme than an actual observed difference in means.

FIG. 7 is a graph illustrating an example of a normal distribution 700 wherein a p-value can be calculated to obtain anytime-valid confidence sequences for multiple treatments according to certain embodiments. An area 702 defines the p-value for this distribution. The 95% confidence sequence width is shown by line 704. Conversion rate, which in this example is based on email opens, is represented by p. This distribution is for treatment D as compared to a baseline treatment A. The width of the distribution is the anytime-valid variance. FIG. 8 is a flowchart of another example of a process 800 for providing anytime-valid confidence sequences for multiple treatments according to certain embodiments. In this example, one or more computing devices carry out the process by executing suitable program code. For example, computing device 101 may carry out the process by executing analytics application 102. Communication server 106, as another example, may also carry out some operations of process 800.

At block 802 of process 800, messaging treatments are generated and stored. These messaging treatments may be stored in the computing device running the analytics application or in the communication server. They may be generated based on input received from input device 140. At block 804, assuming these messaging treatments include messages to be sent as email, push messages, SMS, or similar techniques, processing proceeds to block 806 where the computing device transmits test messages to groups of recipients in a manner like that described with respect to block 202 of FIG. 2. However, if the messaging treatments involve a web site or portions of a web site, processing proceeds to block 808, where the computing device generates the independent groups of recipients based on cookies, user credentials, or both. At block 810 in this case, the computing device publishing the messaging to the web site for a specified period. Each of the test messages corresponds to the cookie or user credentials that correspond to the relevant group of recipients, so that each group sees a different web site presentation and the reaction from recipients in that group, for example, clicks, can be determined and tracked. By using portions of a web site, as examples, a specific image, font color, or background color can be tested for revenue. For example, specific colors for cart additions or for pay walls for subscriptions can be tested.

Staying with FIG. 8, at block 812, the computing device assays, over time, a metric corresponding to the message response for each independent group of recipients. At block 814, the computing device derives the comparative difference between the assayed value of the metric the baseline value of the metric for each test message for that message's group of recipients. The metric is continuously determined, with the value changing as the test proceeds. At block 816, the computing device estimates, over time, the variance of an average of the metric for the test messages. These operations proceed in the same manner as those described with respect to blocks 204-208 of FIG. 2.

At block 818 of FIG. 8, the computing device produces an initial p-value for each messaging treatment using an initial estimated confidence value. The initial p-value is corrected to control type I error using an error correction module configured to provide, as examples, a Bonferroni correction, a Benjamini-Hochberg procedure, or a combination of the two. The resulting error-corrected p-value is updated iteratively over time and used to calculate the confidence values that can be output over time to provide anytime-valid confidence sequences. Bonferroni correction for null hypotheses controls the family wise error rate. Without some form of correction, the family wise error rate increases with the number of treatment arms in the experiment. Applying Bonferroni correction forces the family wise error rate to near zero. The Benjamini-Hochberg procedure controls false discovery rate. Assuming a false discovery rate threshold of 0.05, the threshold can be crossed with as few as five treatment arms without using a procedure to correct the false discovery rate. The scaling of the asymptotic, cumulative false discovery rate is well controlled even as the number of treatment arms in an experiment increases as shown in FIGS. 3-6.

At block 820 in FIG. 8, the computing device calculates, iteratively and over time, and based on the variance and an error-corrected p-value, a current confidence value for each messaging treatment. The current confidence values form the sequences of anytime-valid confidence values and are produced in a manner similar to that discussed with respect to block 210 of FIG. 2. The functions included in block 814 through 820 and discussed with respect to FIG. 8 can be used in implementing a step for producing, iteratively over time, a current confidence value corresponding to a current difference value for a difference between an assayed value of the metric and a baseline value of the metric.

To calculate p-values, and in turn, confidence values, a confidence sequence for the difference in the metric values for the baseline messaging treatment and each individual treatment can be determined. The confidence sequence can then be “inverted” to find a p-value, using a normal distribution as the sampling distribution of the mean difference. Consider two treatments with treatment IDs 0 and 1, and N=N_0+N_1 total visitors across the two treatments. In terms of the sample means \hat{μ}₀ and \hat{μ}₁ and standard deviations \hat{σ}₀ and \hat{σ}₁, the confidence sequence for the difference is given by:

$${CS}_{1 - α} := ( {\tilde{μ}}_{1} - {\tilde{μ}}_{0} ) \pm \sqrt{\frac{N}{N - 1} [ \frac{N}{{N}_{0}} ( {\hat{σ}}_{0}^{2} + {\hat{μ}}_{0}^{2} ) + \frac{N}{{N}_{1}} ( {\hat{σ}}_{1}^{2} + {\hat{μ}}_{1}^{2} ) - {( {\hat{σ}}_{1}^{2} + {\hat{μ}}_{0}^{2} )}^{2} ]} .$$

$$\sqrt{\frac{2 ( N {ρ}^{2} + 1 )}{{N}^{2} {ρ}^{2}} log ( \frac{\sqrt{N {ρ}^{2} + 1}}{α} )} + … .$$

To find a p-value, the confidence bounds given by a confidence sequence can be interpreted as the normalizing factor for the test statistic of interest. For a regular hypothesis test for the difference in means, the test statistic is defined as:

$$z = \frac{{\hat{μ}}_{1} - {\hat{μ}}_{0}}{{\hat{σ}}_{p}} ,$$

where \hat{σ}ₚ is the pooled sample standard deviation. For large enough sample sizes, the t-test and the z-test are equivalent, and the p-value can be defined in terms of the cumulative distribution of the normal:

$$p - value = 2 ( 1 - Φ ( \vert z \vert ) ) .$$

Then, a 1-α confidence interval for the difference in means can be given by:

$${CI}_{1 - α} := \{ ( {\hat{μ}}_{1} - {\hat{μ}}_{0} ) \pm {z}_{1 - \frac{α}{2}}^{*} {\hat{σ}}_{p} \} ,$$

where

$${z}_{1 - \frac{a}{2}}^{*}$$

is a value for the standard normal. As an example, for α=0.05, z≈1.96. To derive an equivalent “always valid” p-value, the (1-α) confidence sequence is used as:

$${CI}_{1 - α} := \{ ( {\hat{μ}}_{1} - {\hat{μ}}_{0} ) \pm {Γ}_{N} \} ,$$

Where I′_{N} is the long expression for CS₁₋ₐ just given. An analogous relationship can be created between the confidence bounds and the test statistic as shown below. The denominator is the anytime-valid variance:

$$\tilde{z} = \frac{{\hat{μ}}_{1} - {\hat{μ}}_{0}}{( {Γ}_{N} / {z}_{1 - \frac{a}{2}}^{*} )}$$

The p-value is then given by:

$$p - value = 2 ( 1 - Φ ( \vert \tilde{z} \vert ) ) .$$

Continuing with FIG. 8, if the sequences of values and metric differences are to be optionally displayed at block 824, the various values are dynamically displayed at block 826. These values are dynamically displayed while being updated over time. The difference value can be selectively displayed based on input received through input device 140. The functions included in block 814 through 820 and discussed with respect to FIG. 8 can be used in implementing a step for producing, iteratively over time, a current confidence value corresponding to a current difference value for a comparative difference between an assayed value of the metric for the message response and a baseline value of the metric.

In this example, at least the current confidence value, and the current difference value are displayed, and values are updated so that confidence values are sequentially displayed until the end of the experiment. In some examples, a display window or GUI can be scrolled to view messaging treatments and the values can continue to be updated. In some examples, the analytics application can be configured to display valid current confidence values and difference values along with test message identifiers in visual alignment on a display device such as display device such as presentation device 108. The display device can be configured by the analytics application to be scrollable while being iteratively updated over time with the sequence of values.

In some embodiments, at any time, up to and including, the conclusion of the test, the best test message can be selected and deployed as appropriate for example through input to computing device 101 through input device 140. In other embodiments, this selection and deployment can take place programmatically. For example, at block 828 of process 800 in FIG. 8, the computing device can identify, based on a final confidence value and based on a final difference value, a selected test message. In this example, the computing device can transmit the selected test message to an expanded group of recipients. In some examples, this message may be an email message, SMS, message or push message. In other examples the transmittal of the selected massage may include publishing a final version of a web site that includes the design, color scheme, descriptive text, fonts, or any other characteristics that produced the best results in the test.

FIG. 9 is a screenshot 900 of an example of a dynamic display for providing anytime-valid confidence sequences for multiple treatments according to certain embodiments. Screenshot 900 lists current test message identifiers 902 for various messaging treatments. This dynamic display may be presented, as an example, in a window of a GUI on presentation device 108. In this example, the messages are referred to as “variants.” Header 904 provides a label for each column of the display that includes live data on the variants under test. The column furthest to the left after the variants column indicates the number of people in each independent group both by number and percentage. The next column indicates the number of message clicks (responses), again both by number and percentage. The next column indicates the conversion rate in terms of clicks per person. The following column lists the “lift” for each messaging treatment. In this context, the lift is the difference between the value of the metric (clicks) for each message as compared to the baseline. Note that the first message has a lift of 0.0, because it represents the baseline. The last column of the display is the current confidence value for each messaging treatment.

Staying with FIG. 9, area 906 lists the pages, rows, and messages displayed for the experiment. In this particular example, there is one page of messaging treatments totaling 80 rows. Thus, 80 messages are being tested, including the baseline message. Currently, statistics for messaging treatments one through five are being displayed. Scroll bar 908 provides the capability to selectively scroll through results of the test in process while statistics are being updated over time. The analytics application can display these confidence values and other values sequentially over time along with the current difference, or “lift,” updating all of these values while maintaining the accuracy of the values and providing a visual display that can be scrolled to provide for examination of the values for all treatments as they are updated while the experiment proceeds.

FIG. 10 is a diagram of an example of a computing system that can provide anytime-valid confidence sequences when testing multiple messaging treatments according to certain embodiments. System 1000 includes a processing device 1002 communicatively coupled to one or more memory devices. The processing device 1002 executes computer-executable program code stored in the memory component 1004. Examples of the processing device 1002 include a microprocessor, an application-specific integrated circuit (“ASIC”), a field-programmable gate array (“FPGA”), or any other suitable processing device. The processing device 1002 can include any number of processing devices, including a single processing device. The memory component 1004 includes any suitable non-transitory computer-readable medium for storing data, program code instructions, or both. A computer-readable medium can include any electronic, optical, magnetic, or other storage device capable of providing a processor with computer-readable, executable instructions or other program code. The memory component can include multiple memory devices to provide a computer-readable medium. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, and JavaScript.

Still referring to FIG. 10, the computing system 1000 may also include a number of external or internal devices, for example, input or output devices. For example, the computing system 1000 is shown with one or more input/output (“I/O”) interfaces 1006. An I/O interface 1006 can receive input from input devices or provide output to output devices (not shown). Output may be provided using the interface module 130 of the analytics application 102. One or more buses 1008 are also included in the computing system 1000. A bus 1008 communicatively couples one or more components of a respective one of the computing system 1000. The processing device 1002 executes program code that configures the computing system 1000 to perform one or more of the operations described herein. The program code includes, for example, analytics application 102 or other suitable applications that perform one or more operations described herein. The program code may be resident in the memory component 1004 or any suitable computer-readable medium and may be executed by the processing device 1002 or any other suitable processor. Memory component 1004, includes variance module 114, confidence module 120, difference module 111, and response module 112.

The system 1000 of FIG. 10 also includes a network interface device 1012. The network interface device 1012 includes any device or group of devices suitable for establishing a wired or wireless data connection to one or more data networks. Non-limiting examples of the network interface device 1012 include an Ethernet network adapter, a wireless network adapter, and/or the like. The system 1000 is able to communicate with one or more other computing devices (e.g., another computing device executing other software, not shown) via a data network (not shown) using the network interface device 1012. Network interface device 1012 can also be used to communicate with the communication server 106.

Staying with FIG. 10, in some embodiments, the computing system 1000 also includes the presentation device 1015. A presentation device 1015 can include any device or group of devices suitable for providing visual, auditory, or other suitable sensory output. In examples, presentation device 1015 provides the dynamic display of anytime-valid confidence sequences for multiple treatments. Non-limiting examples of the presentation device 1015 include a touchscreen, a monitor, a separate mobile computing device, etc. In some aspects, the presentation device 1015 can include a remote client-computing device that communicates with the computing system 1000 using one or more data networks. System 1000 may be implemented as a unitary computing device, for example, a notebook or mobile computer. Alternatively, as an example, the various devices included in system 1000 may be distributed and interconnected by interfaces or a network with a central or main computing device including one or more processors.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “generating,” “assaying,” “processing,” “computing,” “determining,” and “identifying” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method comprising:
transmitting each of a plurality of test messages to an independent group of recipients;
assaying, over time, using a response module, a metric corresponding to a message response from the independent group of recipients for each of the test messages;
deriving, iteratively over time, using a difference module, a comparative difference between an assayed value of the metric for the message response and a baseline value of the metric;
estimating, iteratively over time, using a variance module, a variance of an average of the metric for the plurality of test messages;
calculating a current confidence value using a confidence module, iteratively over time and based on the variance and an error-corrected p-value normalized within confidence bounds, wherein the current confidence value corresponds to a current difference value for the comparative difference; and
dynamically displaying, while updating over time and using an interface module, the current confidence value to produce a confidence sequence.

2. The method of claim 1, further comprising displaying, over time, the current difference value corresponding to the current confidence value.

3. The method of claim 2, further comprising:
identifying, based on a final confidence value and a final difference value, a selected test message from the plurality of test messages; and
transmitting the selected test message to an expanded group of recipients.

4. The method of claim 1, wherein displaying the current confidence value further comprises displaying the current confidence value and a current difference value and a test message identifier, all for each of the plurality of test messages in visual alignment on a display device, wherein the display device is configured to be scrollable based on a number of test messages while being iteratively updated over time.

5. The method of claim 1, wherein the plurality of test messages comprises at least one of a text message, an email message, or a push message.

6. The method of claim 1, wherein the plurality of test messages comprises at least a portion of a web site, the method further comprising:
generating the independent group of recipients based on at least one of a cookie or user credentials; and
publishing the plurality of test messages to the web site for a specified period, wherein each of the test messages corresponds to the cookie or user credentials.

7. The method of claim 1, further comprising:
producing an initial p-value using an initial estimated confidence value; and
correcting the initial p-value using an error correction module to control type I error.

8. A system comprising:
a memory component;
a processing device coupled to the memory component to perform operations of transmitting each of a plurality of test messages to an independent group of recipients, and of dynamically displaying a current confidence value from an anytime-valid confidence sequence:
a response module configured to assay, over time, a metric corresponding to a message response from the independent group of recipients for each of the test messages;
a difference module configured to derive, iteratively over time, a comparative lift for an assayed value of the metric for the message response relative a baseline value of the metric;
a variance module configured to estimate, iteratively over time, a variance of an average of the metric for the plurality of test messages; and
a confidence module configured to calculate, iteratively over time and based on the variance and an error-corrected p-value, the current confidence value to produce the anytime-valid confidence sequence.

9. The system of claim 8, wherein the operations further comprise displaying, over time and in response to an input device, a current lift corresponding to the current confidence value.

10. The system of claim 9, wherein the operations further comprise:
identifying, based on at least one of a final confidence value and a final lift, a selected test message from the plurality of test messages; and
transmitting the selected test message to an expanded group of recipients.

11. The system of claim 8, wherein the operation of dynamically displaying the current confidence value further comprises displaying the current confidence value, a current lift, and a test message identifier, all for each of the plurality of test messages in visual alignment on a display device, wherein the display device is configured to be scrollable based on a number of test messages while being iteratively updated over time.

12. The system of claim 8, wherein the plurality of test messages comprises at least one of a text message, an email message, or a push message.

13. The system of claim 8, wherein the plurality of test messages comprises at least a portion of a web site, and wherein the operations further comprise:
generating the independent group of recipients based on at least one of a cookie or user credentials; and
publishing the plurality of test messages to the web site for a specified period, wherein each of the test messages corresponds to the cookie or user credentials.

14. The system of claim 8, wherein the operations further comprise producing an initial p-value using an initial estimated confidence value and the system further comprises an error correction module configured to perform at least one of a Bonferroni correction or a Benjamini-Hochberg procedure to correct the initial p-value to control type I error and produce the error-corrected p-value.

15. A non-transitory computer-readable medium storing executable instructions, which when executed by a processing device, cause the processing device to perform operations comprising:
transmitting each of a baseline message and a plurality of test messages to an independent group of recipients;
assaying, over time, a metric corresponding to a message response from the independent group of recipients for each of the test messages;
a step for producing, iteratively over time, a current confidence value corresponding to a current difference value for a comparative difference between an assayed value of the metric for the message response and a baseline value of the metric; and
dynamically displaying, while updating over time, the current confidence value to produce a confidence sequence.

16. The non-transitory computer-readable medium of claim 15, wherein the executable instructions further cause the processing device to perform a step for displaying, over time and in response to an input device, a current difference value corresponding to the current confidence value.

17. The non-transitory computer-readable medium of claim 15, wherein the operation of displaying the current confidence value further comprises displaying the current confidence value and a current difference value and a test message identifier, all for each of the plurality of test messages in visual alignment on a display device, wherein the display device is configured to be scrollable based on a number of test messages while being iteratively updated over time.

18. The non-transitory computer-readable medium of claim 15, wherein the plurality of test messages comprises at least one of a text message, an email message, or a push message.

19. The non-transitory computer-readable medium of claim 15, wherein the plurality of test messages comprises at least a portion of a web site, and the executable instructions further cause the processing device to perform operations comprising:
generating the independent group of recipients based on at least one of a cookie or user credentials; and
publishing the plurality of test messages to the web site for a specified period, wherein each of the test messages corresponds to the cookie or user credentials.

20. The non-transitory computer-readable medium of claim 15, wherein the executable instructions further cause the processing device to perform operations comprising:
producing an initial p-value using an initial estimated confidence value; and
correcting the initial p-value to control type I error, using at least one of a Bonferroni correction or a Benjamini-Hochberg procedure to produce an error-corrected p-value.
